(19) United States
(12) Patent Application Publication
(10) Pub. No.: US 2004/0107050 A1
(43) Pub. Date: Jun. 3, 2004

(54) Control and display facility for vehicle

(76) Inventor: Hsiu-Chu Hsu Li, Hsin Chuang City (TW)

Correspondence Address: HSU LI, Hsiu Chu, P.O. Box 4-67, Hsin Chuang, Taipei, TW

(21) Appl. No.: 10/307,731

(22) Filed: Nov. 29, 2002

(51) Int. Cl. G01C 21/26

(52) U.S. Cl. 701/213

(57) ABSTRACT

A control facility for vehicle includes a global system for mobile communication (GSM) device having a processor device, a control panel, and a displayer. A satellite positioning or locating device and a radar detector are coupled to the GSM device, to show position of the vehicle in the displayer. A camera device may further be coupled to the GSM device, to shoot environment of the vehicle to the displayer. The image taken by the camera device may be alternatively shown in the displayer, for allowing the driver to clear know the environment behind the vehicle.

### BACKGROUND OF THE INVENTION

1. Field of the Invention

The present invention relates to a control and display facility, and more particularly to a control and display facility for vehicles.

2. Description of the Prior Art

Typical global system for mobile communication (GSM) devices or facilities have been developed and applied or attached to vehicles, airplanes, boats, or even military vehicles, for positioning the vehicles, or for supplying information to the vehicle drivers or users, and for allowing the vehicle drivers or passengers to dial and to receive phones. However, the GSM facilities may not detect or provide information of the vehicles while the vehicles are moving backwardly.

Several radar detectors have been developed for attaching to the vehicles, in order to detect the backwardly movement of the vehicles. However, while the vehicles are moving backwardly, no control or display facilities may be used to show the status of the vehicle in the control panel of the vehicles, such that the vehicle drivers have to hear the warning sounds generated by the radar detectors only, and may not view the position or situation of the vehicles.

The present invention has arisen to mitigate and/or obviate the afore-described disadvantages of the conventional vehicle backwardly moving problems.

### SUMMARY OF THE INVENTION

The primary objective of the present invention is to provide a control and display facility including a displayer device for showing the position or situation of the vehicles.

The other objective of the present invention is to provide a control and display facility including a GSM device coupled to the displayer device for sending the position or the backwardly movement of the vehicles to customer service centers or the like.

The further objective of the present invention is to provide a control and display facility including a camera device coupled to the displayer device for shooting and showing the position or situation of the vehicles to the displayer device.

In accordance with one aspect of the invention, there is provided a control facility for vehicle comprising a global system for mobile communication (GSM) device including a processor device, a control panel, and a displayer, a satellite positioning or locating device coupled to the GSM device, to show position of the vehicle in the displayer, and a radar detector coupled to the GSM device, to show situation of the vehicle in the displayer.

The radar detector may be coupled to the satellite positioning or locating device.

A camera device may further be provided and coupled to the GSM device, to shoot environment of the vehicle to the displayer. The view or image taken by the camera device may be alternatively shown in the displayer.

A navigation information device and/or an electrical counting device and/or a memory device may further be provided and coupled to the GSM device for providing various information to the GSM device.

The GSM device includes a tape recording device, a general purposes radar (GPS) antenna, a GSM antenna, a radio frequency (RF) antenna, a microphone, a radio, an ear piece, a head set, and an anti-theft device coupled to the processor device, and/or a switch button for coupling to customer service center, and/or a steering wheel quick actuating switch, and an air bag coupled to the processor device.

The displayer may include one area to show position of the vehicle, another area to show GSM status or conditions of the GSM device, such as the signal strengths and messages of the GSM device, and a further area to show GSM words or messages, such as functions, selections, items, or other information of the GSM device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram showing a control facility in accordance with the present invention;

FIG. 2 is a block diagram showing a GSM control device of the control facility;

FIG. 3 is a plan schematic view of a displayer device of the control facility;

FIG. 4 is a block diagram showing the telephone communicating functions for the GSM control device of the control facility;

FIG. 5 is a plan schematic view showing the screen of the displayer device of the control facility;

FIG. 6 is a flow chart illustrating the operations of the displayer device of the control facility;

FIG. 7 is a flow chart illustrating the operations of a vehicle backwardly moving detector device of the control facility; and

FIG. 8 is a flow chart illustrating the operations of the camera device of the control facility.

### DETAILED DESCRIPTION OF THE PREFERRED EMBODIMENT

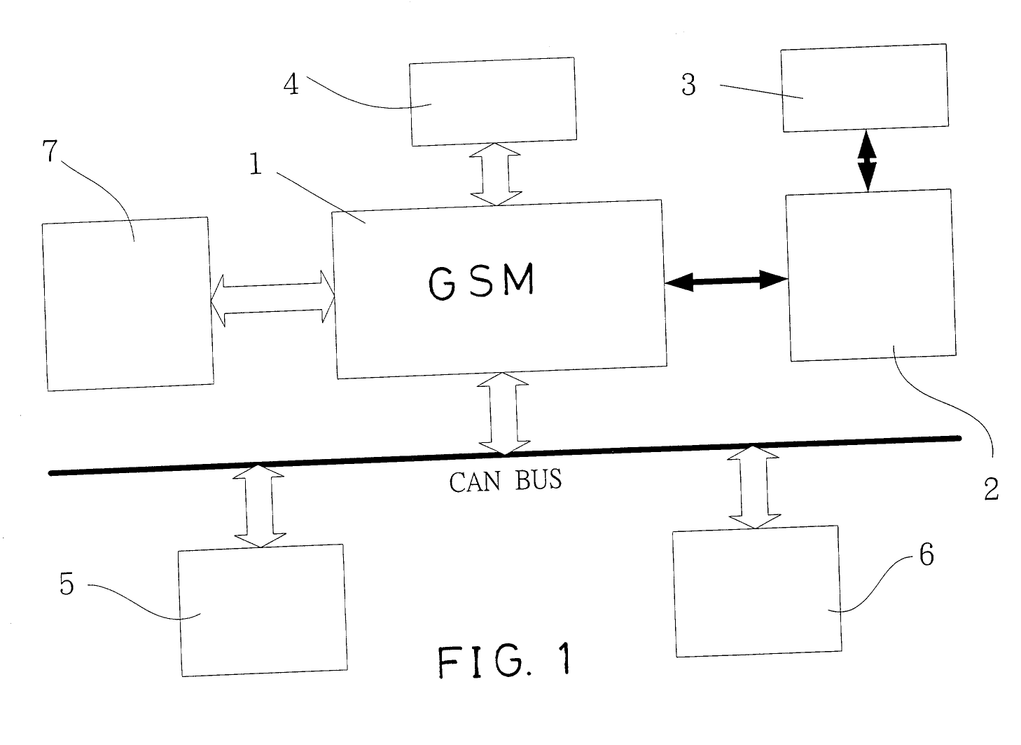

Referring to the drawings, and initially to FIG. 1, a control and display facility in accordance with the present invention comprises a global system for mobile communication (GSM) device 1, a satellite positioning or locating device 2, a radar detector device 3, a camera device 4, a navigation information device 5, an electrical counting device 6, and a memory device 7 for storing or memorizing various languages therein.

The control and display facility in accordance with the present invention is developed and provided for applying or attaching to vehicles, airplanes, boats, or even military vehicles, and for positioning the vehicles, or for supplying information to the vehicle drivers or users, and for allowing the vehicle drivers or passengers to dial and to receive phones. etc.

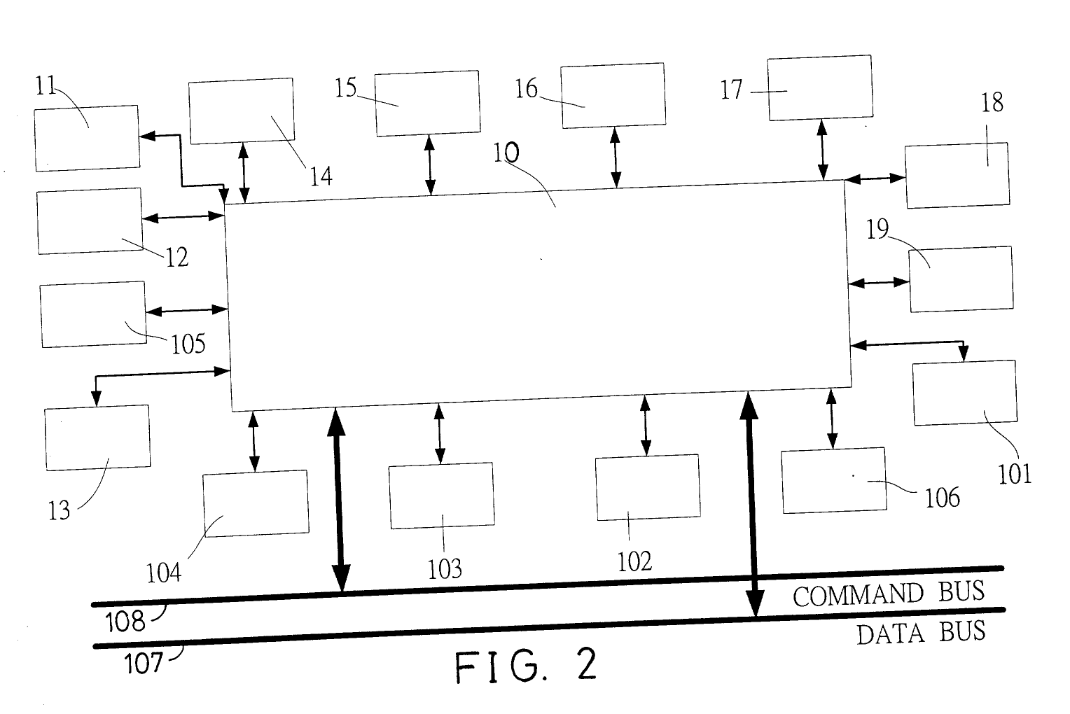

Referring next to FIG. 2, illustrated is a global system for mobile communication (GSM) device 1 which includes a processor device 10 for controlling or processing purposes. The GSM device 1 further includes a GSM module 11, a tape recording device 12, a control panel 13, a general purposes radar (GPS) antenna 14, a GSM antenna 15, a radio frequency (RF) antenna 16, a microphone 17, a displayer 18, a radio 19, a switch button 101 for coupling to customer service center, a steering wheel quick actuating switch 102, an air bag 103, an ear piece 104, a head set 105, and an anti-theft device 105 coupled to the processor device 10.

The GSM module 11 may be coupled to the control panel 13 via the processor device 10, and may be transmitted or communicated with various network systems via a data can bus 107 or a command can bus 108. The GSM module 11 may be directly controlled or operated with or via the control panel 13. A typical telecommunication device or module or telephone card (not shown) may be plugged to the GSM module 11, for allowing the users to dial phones or to receive phones by or via the control panel 13.

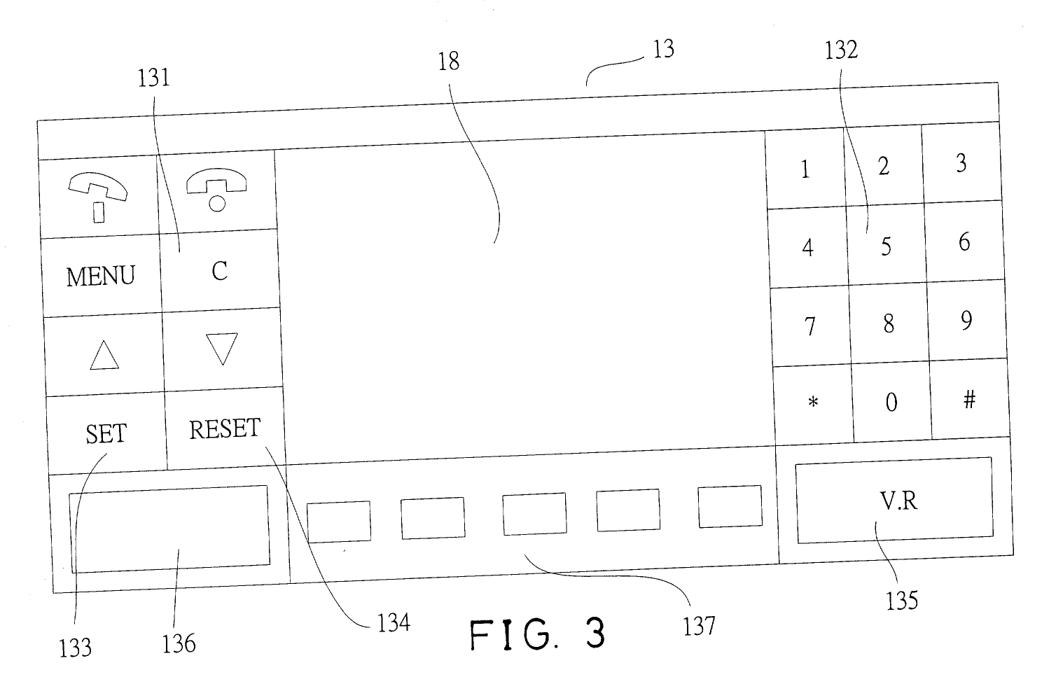

Referring next to FIG. 3, the control panel 13 includes a number of keys or buttons 131 for controlling or dialing or receiving phones, a set of numeral keys 132, an anti-theft device setting key 133, a reset key 134 for quickly resetting purposes, a signal switching key 135 for switching between voice signals, image signals, or the like, a customer service center connecting key 136, and a number of information or indicating lights 137. The displayer 18 may also be disposed or arranged within the control panel 13.

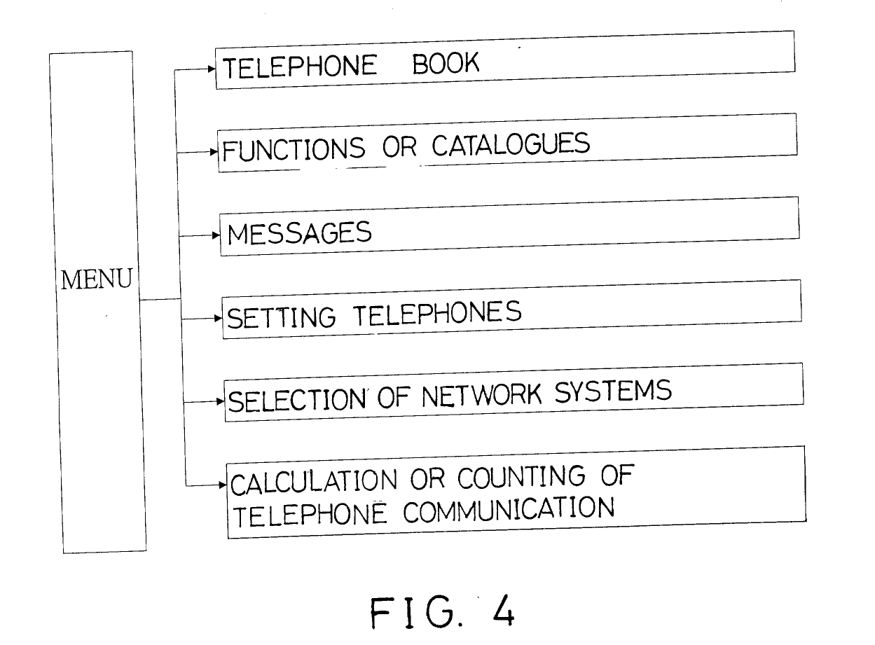

Referring next to FIG. 4, the keys or buttons 131 may be used to obtain various information, such as the telephone book, the functions or catalogues, the messages, the setting of telephones, the selection of network systems, the calculation or counting of telephone communication, etc.

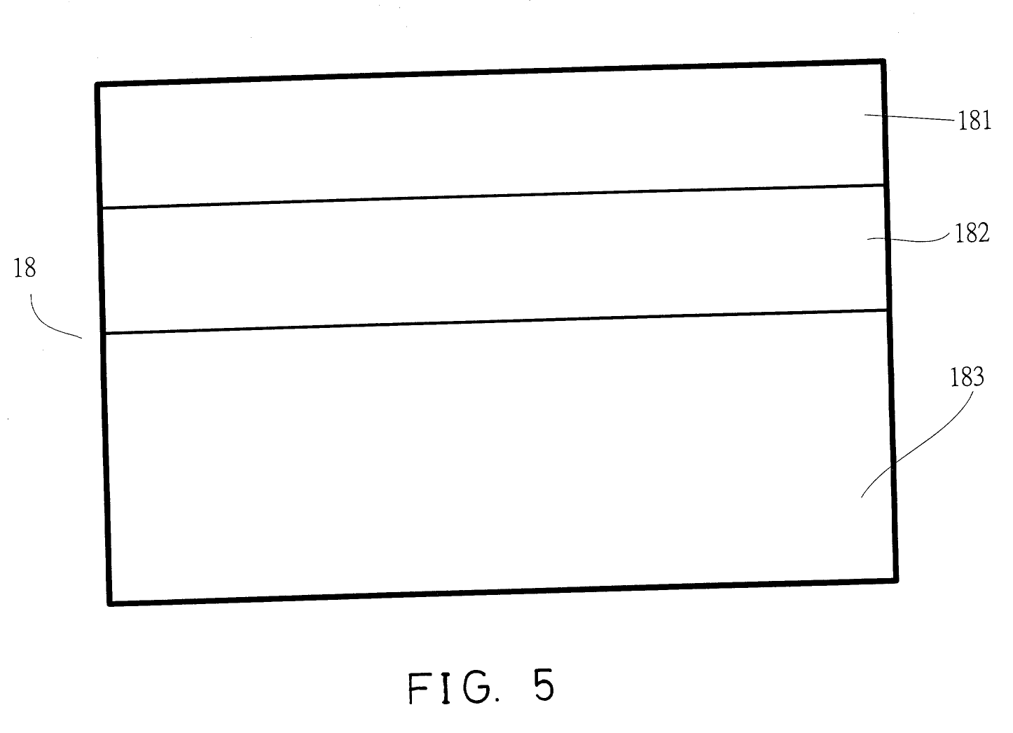

Referring next to FIG. 5, the displayer 18 may include several areas 181-183 for displaying or showing various informations or messages. For example, one of the areas 181 may be used to show the backwardly driving condition, such as the distance, the direction, etc., of the vehicle, that may be received or obtained from the radar detector device 3.

The intermediate area 182 may be used to show the GSM status or conditions of the GSM module 11, such as the signal strengths and messages of the GSM module 11. The lower area 183 may be used to show GSM words or messages, such as functions, selections, items, or other information of the GSM module 11.

In operation, as shown in FIG. 1, the GSM device 1 may be connected to or communicated with the customer service center via the satellite positioning or locating device 2, and to receive information from the customer service center. The information or indicating lights 137 may be actuated or energized by the signals or information received from the customer service center, in order to show any information concerning dining, clothing, lodging or living, traveling, entertainment, etc.

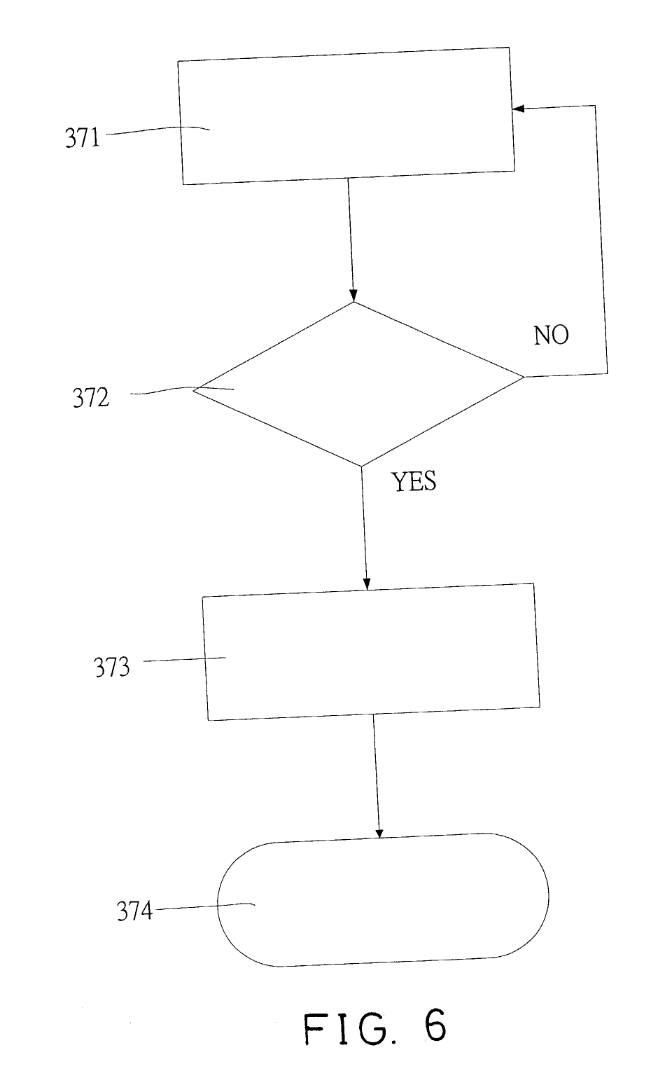

For example, as shown in FIG. 6, when the GSM device 1 receives signals or information from the customer service center, a process 371 may be actuated to light up or to energize either or some or all of the lights 137 (FIG. 3). Another process 372 may then be conducted to check whether an end or terminal command is received or not.

When an end or terminal command has been received, a process 373 may be conducted to switch off all of the lights 137, and then moved to the end process 374. On the contrary, when no end or terminal command has been received, the process 371 may be continuously conducted to light up or to actuate or to energize either or some or all of the lights 137, until receiving the end or terminal command.

As shown in FIG. 1, the radar detector device 3 of the control and display facility may be connected to or communicated with the GSM device 1 directly or via the satellite positioning or locating device 2, for detecting and sending the location or position of the vehicle to the GSM device 1. The user may then use the customer service center connecting key 136 of the control panel 13 to communicate with or to send out the location or position information of the vehicle to the customer service center.

The distances, directions, or locations of the vehicle, particularly while moving rearwardly, that are detected by the radar detector device 3 may thus be sent to the satellite positioning or locating device 2, and may then be shown in the upper area 181 of the displayer 18, such that the user or the driver may clear see or view or know the location and position of the vehicle relative to the environment, and such that the driver may safely drive the vehicle.

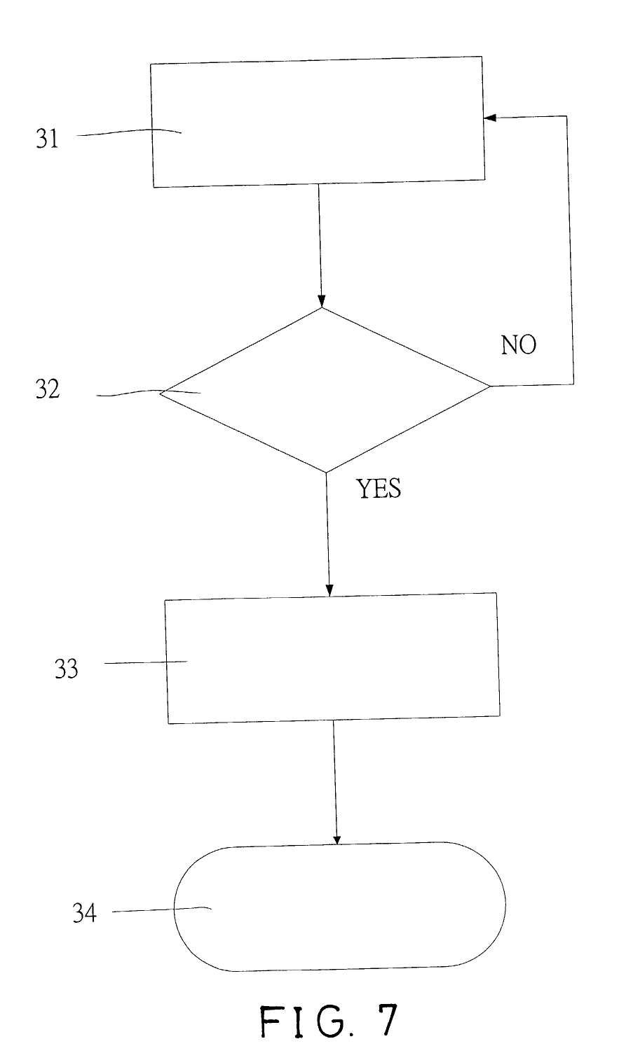

For example, as shown in FIG. 7, when the gear of the vehicle is moved to “R” in order to drive the vehicle backwardly, a process 31 may be actuated to operate the displayer 18, in order to show, in such as the areas 181, the backwardly driving condition, such as the distance, the direction, etc., of the vehicle, that may be received or obtained from the radar detector device 3. Another process 32 may then be conducted to check whether an end or terminal command is received or not.

When an end or terminal command has been received, a process 33 may be conducted to clear the information or messages shown in the displayer 18, and then moved to the end process 34. On the contrary, when no end or terminal command has been received, the process 31 may be continuously conducted to show the backwardly driving condition until receiving the end or terminal command.

The camera device 4 may also be coupled to the GSM device 1, to take picture or to film or to tape the rear view or the environment behind the vehicle, that may be sent to and shown in the displayer 18, for allowing the driver to clear see or view or know the location and position behind the vehicle.

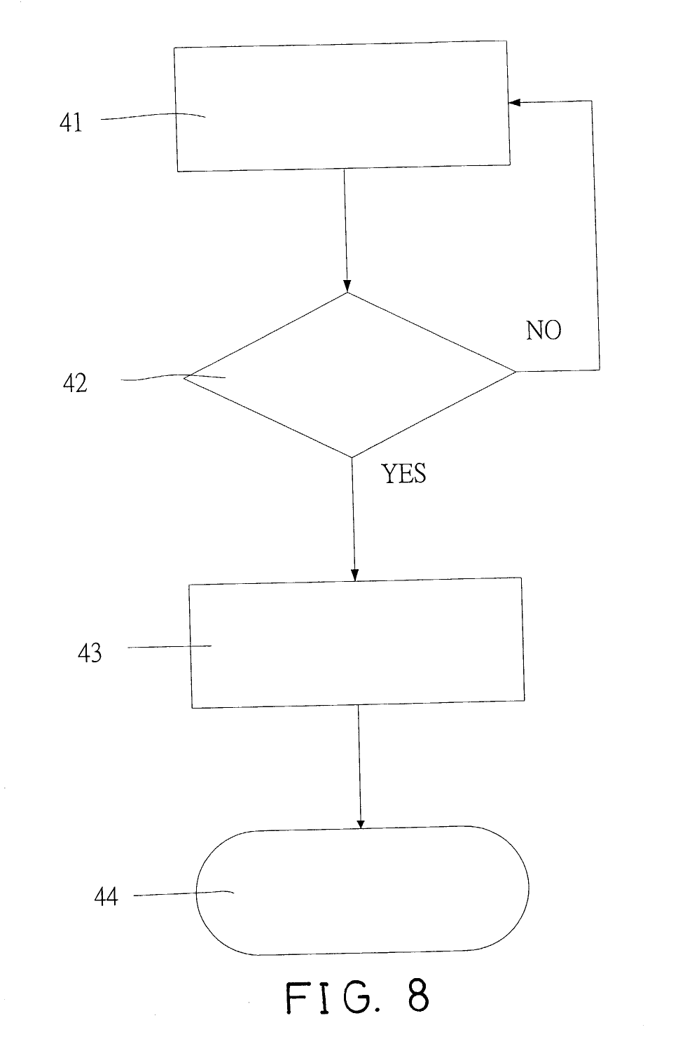

For example, as shown in FIG. 8, when the gear of the vehicle is moved to “R” in order to drive the vehicle backwardly, a process 41 may be actuated to operate the displayer 18, and to actuate the signal switching key, 135 to switch and to show the image taken by the camera in the displayer 18, in such as the areas 181, for allowing the backwardly driving condition, such as the distance, the direction, etc., of the vehicle, taken by the camera device 4 to be shown and seen via the displayer 18. Another process 42 may then be conducted to check whether the camera device 4 is still working or not.

When the camera device 4 is not worked or energized, a process 43 may be conducted to switch back to show the information or messages from the radar detector device 3 in the displayer 18, and then moved to the end process 34. On the contrary, when the camera device 4 is still working, the process 41 may be continuously conducted to switch and to show the backwardly driving condition taken by the camera device 4.

The navigation information device 5 may be used to provide various navigation or traveling information to the users. The electrical counting device 6 may be used to counting or calculating the fees or tolls for using bridges, highway, telephone calls, or the like. The memory device 7 may be used for storing or memorizing various languages therein, and for converting the messages or information to different languages.

In operation, the radar detector 3 may be coupled to the GSM device 1 directly, or indirectly via the satellite positioning or locating device 2, for allowing the location and position behind the vehicle to be seen by the users via the displayer 18. The camera device 4 may also be used to take picture and to show the environment behind the vehicle in the displayer 18, instead of the information from the radar detector 3.

Accordingly, the control and display facility in accordance with the present invention includes a displayer device for showing the position or situation of the vehicles, and includes a radar detector device and/or a camera device coupled to the displayer device for shooting and showing the position or situation of the vehicles to the displayer device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A control facility for vehicle comprising:
a global system for mobile communication (GSM) device including a processor device, a control panel, and a displayer,
a satellite positioning or locating device coupled to said GSM device, to show position of the vehicle in said displayer, and
a radar detector coupled to said GSM device, to show situation of the vehicle in said displayer.

2. The control facility according to claim 1, wherein said radar detector is coupled to said satellite positioning or locating device.

3. The control facility according to claim 1 further comprising a camera device coupled to said GSM device, to shoot environment of the vehicle to said displayer.

4. The control facility according to claim 1 further comprising a navigation information device coupled to said GSM device.

5. The control facility according to claim 1 further comprising an electrical counting device coupled to said GSM device.

6. The control facility according to claim 1 further comprising a memory device coupled to said GSM device.

7. The control facility according to claim 1, wherein said GSM device includes a tape recording device, a general purposes radar (GPS) antenna, a GSM antenna, a radio frequency (RF) antenna, a microphone, a radio, an ear piece, a head set, and an anti-theft device coupled to said processor device.

8. The control facility according to claim 1, wherein said GSM device includes a switch button for coupling to customer service center.

9. The control facility according to claim 1, wherein said GSM device includes a steering wheel quick actuating switch, and an air bag coupled to said processor device.

10. The control facility according to claim 1, wherein said displayer includes an area to show position of the vehicle.
